(19) United States
(12) Patent Application Publication
(10) Pub. No.: US 2026/0119920 A1
(43) Pub. Date: Apr. 30, 2026

(54) APPARATUS AND METHOD FOR QUESTION-AND-ANSWER-BASED TABLE INSIGHT INFERENCE

(71) Applicant: UIF (UNIVERSITY INDUSTRY FOUNDATION), YONSEI UNIVERSITY, Seoul (KR)

(72) Inventors: Dongha Lee, Seoul (KR); Kwangwook Seo, Seoul (KR)

(73) Assignee: UIF (UNIVERSITY INDUSTRY FOUNDATION), YONSEI UNIVERSITY, Seoul (KR)

(21) Appl. No.: 18/933,653

(22) Filed: Oct. 31, 2024

(30) Foreign Application Priority Data
Oct. 28, 2024 (KR) 10-2024-0149025

(51) Int. Cl. G06N 5/04; G06N 20/00

(52) U.S. Cl. CPC G06N 5/04; G06N 20/00

(57) ABSTRACT

Disclosed is an apparatus and method for question-and-answer-based table insight inference, and the apparatus includes: a knowledge extractor configured to extract knowledge by progressively detailing the knowledge from an overall aspect, which is referred to as coarse knowledge, to detailed knowledge, which is referred to as fine-grained knowledge, in a table representing a reference summary and structured data; a knowledge quality enhancer configured to perform refinement based on factuality verification of the extracted knowledge and to select important knowledge meeting or exceeding a predetermined threshold through importance scoring; a reasoner trainer configured to perform question generation training to analyze the reference summary and the table data so as to generate questions for identifying the important knowledge, and to perform evidence-insight generation training to derive an answer with a reliability meeting or exceeding a predetermined threshold for each of the questions; and a summary generator configured to incorporate questions and answers about the important knowledge into an insight summary.

### CROSS-REFERENCE TO RELATED APPLICATION

This application claims, under 35 USC § 119(a), the benefit of Korean Patent Application No. 10-2024-0149025 filed on Oct. 28, 2024, the entire contents of which is incorporated herein by reference.

### TECHNICAL FIELD

The present disclosure relates to a technology for providing question-and-answer-based inference, and more specifically, to an apparatus and method for question-and-answer-based table insight inference, which are capable of extracting knowledge from a table, selecting important information, and incorporating questions and answers about the important knowledge into an insight summary.

### BACKGROUND

Table data is emerging as a key knowledge repository that facilitates data analysis and offers users concise and structured information representation. Since understanding complex table data may be time-consuming, there is a need for a text generation system capable of accurately summarizing the provided table data.

One approach to solving the task of summarizing table data is to use a neural network model as an end-to-end summary generator. However, this model encounters the challenge of identifying all the necessary information in an end-to-end approach. Furthermore, tasks that provide questions and answers about table data are provided with explicit instructions (i.e., input queries) for generating answers, whereas tasks that summarize table data lack direct control over what information should be retrieved from the table.

Therefore, the challenge of selecting the necessary evidence for summarization from table data remains a difficult problem.

### PRIOR ART LITERATURE

### Patent Document

Korean Patent Application Publication No. 10-2022-0039576 (Mar. 29, 2022)

### DESCRIPTION

### Problem to be Solved

In view of the above, the present disclosure provides an apparatus and method for question-and-answer-based table insight inference, which are capable of extracting knowledge from a table and performing factuality-verification-based refinement on the extracted knowledge.

The present disclosure also provides an apparatus and method for question-and-answer-based table insight inference, which are capable of analyzing table data and generating questions to find important knowledge.

The present disclosure also provides an apparatus and method for question-and-answer-based table insight inference, which are capable of deriving an answer with a reliability meeting or exceeding a predetermined threshold for a question.

The present disclosure also provides an apparatus and method for question-and-answer-based table insight inference, which are capable of deriving implicit relationships or patterns in table data based on questions and answers about important knowledge and incorporating the derived questions and answers into an insight summary through in-depth analysis.

### Solution

There is provided is an apparatus for question-and-answer-based table insight inference, and the apparatus includes: a knowledge extractor configured to extract knowledge by progressively detailing the knowledge from an overall aspect, which is referred to as coarse knowledge, to detailed knowledge, which is referred to as fine-grained knowledge, in a table representing a reference summary and structured data; a knowledge quality enhancer configured to perform refinement based on factuality verification of the extracted knowledge and to select important knowledge meeting or exceeding a predetermined threshold through importance scoring; a reasoner trainer configured to perform question generation training to analyze the reference summary and the table data so as to generate questions for identifying the important knowledge, and to perform evidence-insight generation training to derive an answer with a reliability meeting or exceeding a predetermined threshold for each of the questions; and a summary generator configured to incorporate questions and answers about the important knowledge into an insight summary.

The knowledge extractor may be further configured to perform an aspect identification process for the table data by analyzing the reference summary based on the coarse knowledge, an aspect-specific question generation process to obtain answers from the table data, and an evidence specification process to derive evidence based on specific cells in the table through fine-knowledge-based analysis for each aspect-specific question.

The knowledge extractor may be further configured to generate the knowledge by collecting the aspects, the questions, and the evidence.

The knowledge quality enhancer may be further configured to determine the refined knowledge by verifying whether the extracted knowledge matches the table data and by removing knowledge containing uncertain or erroneous information from the extracted knowledge.

The knowledge quality enhancer may be further configured to generate a summary based on the refined knowledge, measure a semantic similarity with the reference summary, perform the importance scoring, and select the top K pieces of important knowledge, where K is a natural number.

The reasoner trainer may be further configured to generate aspect-focused questions to find necessary information from the table data through the question generation training.

The reasoner trainer may be further configured to, through the evidence insight generation training, analyze the table data and generate evidence-focused insights to generate reliable insights based on evidence.

The summary generator may be further configured to derive implicit relationships or patterns among the table data based on questions and answers about the important knowledge, predict future trends, and incorporate the predicted future trends into the insight summary.

In another aspect, there is provided a method for question-and-answer-based table insight inference, the method performed by a question-and-answer-based table insight inference apparatus, and the method includes: a knowledge extracting step of extracting knowledge by progressively detailing the knowledge from an overall aspect, referred to as coarse knowledge, to detailed knowledge, referred to as fine-grained knowledge, in a table representing a reference summary and structured data; a knowledge quality enhancing step of performing refinement based on factuality verification of the extracted knowledge and selecting important knowledge meeting or exceeding a predetermined threshold through importance scoring; a reasoner training step of performing question generation training to analyze the reference summary and the table data so as to generate questions for identifying the important knowledge, and performing evidence-insight generation training to derive an answer with a reliability meeting or exceeding a predetermined threshold for each of the questions; and a summary generating step of incorporating questions and answers about the important knowledge into an insight summary.

### Effect

The disclosed technology may have the following effects. However, it should not be construed that the scope of the disclosed technology is limited thereby, as it does not imply that a specific embodiment must include all or exclusively the following effects.

In the apparatus and method for question-and-answer-based table insight inference according to one embodiment of the present disclosure, it is possible to extract knowledge from a table and perform factuality-verification-based refinement on the extracted knowledge.

In the apparatus and method for question-and-answer-based table insight inference according to one embodiment of the present disclosure, it is possible to analyze table data and generate questions to find important knowledge.

In the apparatus and method for question-and-answer-based table insight inference according to one embodiment of the present disclosure, it is possible to derive an answer with a reliability meeting or exceeding a predetermined threshold for a question.

In the apparatus and method for question-and-answer-based table insight inference according to one embodiment of the present disclosure, it is possible to derive implicit relationships or patterns among table data based on questions and answers about important knowledge and incorporate the derived questions and answers into an insight summary through in-depth analysis.

### BRIEF DESCRIPTION OF THE DRAWINGS

FIG. 1 is a drawing illustrating a table insight inference apparatus according to one embodiment of the present disclosure.

FIG. 2 is a diagram illustrating the functional configuration of the apparatus for table insight inference, as shown in FIG. 1.

FIG. 3 is a diagram illustrating the system configuration of the apparatus for table insight inference, as shown in FIG. 1.

FIG. 4 is a flowchart illustrating a table insight inference method according to the present disclosure.

FIG. 5 is a diagram illustrating an example of a table according to one embodiment of the apparatus for table insight inference, as shown in FIG. 1.

FIG. 6 is a diagram illustrating an importance scoring algorithm according to one embodiment of the apparatus for table insight inference, as shown in FIG. 1.

FIG. 7 is a diagram illustrating an example of knowledge extraction according to one embodiment of the apparatus for table insight inference, as shown in FIG. 1.

FIG. 8 is a diagram illustrating an experimental process for measuring the knowledge extraction effect of the apparatus for table insight inference, as shown in FIG. 1.

FIG. 9 is a drawing showing a comparison of summary quality according to the experimental results of FIG. 8.

FIG. 10 is a diagram showing the summary results outside the domain according to the experimental results of FIG. 8.

FIG. 11 is a diagram showing a human evaluation of the knowledge quality generated from the apparatus for table insight inference, as shown in FIG. 1.

FIG. 12 is a diagram showing the effect of knowledge quality improvement resulting from knowledge refinement.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

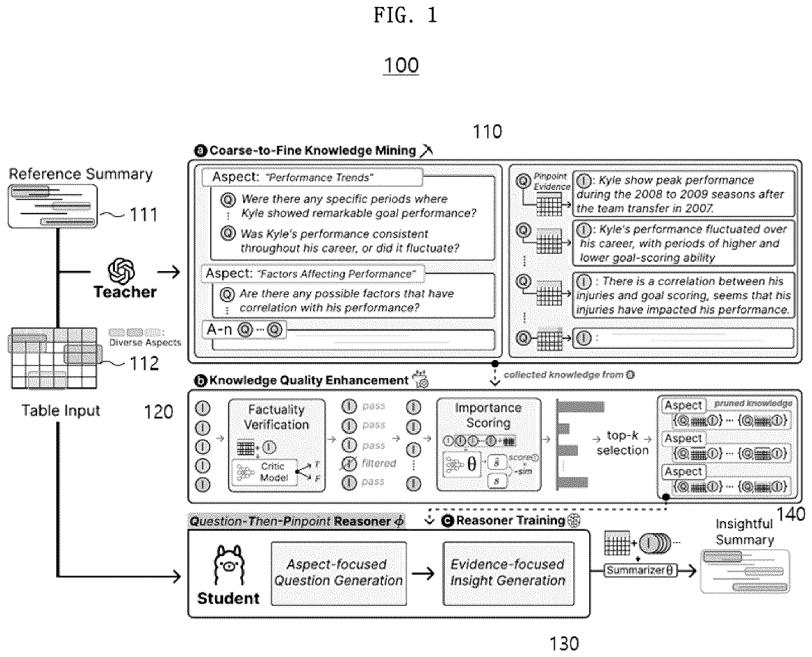

FIG. 1 is a drawing illustrating a table insight inference apparatus according to one embodiment of the present disclosure.

Referring to FIG. 1, an apparatus 100 for table insight inference may include a knowledge extractor 110, a knowledge quality enhancer 120, a reasoner trainer 130, and a summary generator 140.

The apparatus 100 may propose a table reasoning framework, Question-Then-Pinpoint, that constructs a table reasoner capable of performing inference based on summaries of table data. Here, the table reasoner may correspond to a system that extracts meaningful information from structured table data and generates questions or derives answers from the extracted information.

The apparatus 100 may collect knowledge of diverse aspects from a table based on a large language model (LLM) in the knowledge extractor 110. Here, the apparatus 100 may extract and analyze a reference summary 111 from the table based on the LLM and generate checkpoints that provide detailed reasoning paths for generating in-depth knowledge from the table data 112.

Specifically, the apparatus 100 may receive a table and perform an aspect identification process on the table data 112 based on the LLM. Specifically, the apparatus 100 receives a reference summary 111 including a table and a summary of the table, and may extract an abstract item representing one abstract topic from diverse aspects of the table based on the LLM. Here, the abstract item may be expressed by Equation 1 as follows.

$$𝒜 = {\{ {a}_{n} \}}_{n = 1}^{N} \qquad [ Equation 1 ]$$

In this context, αₙ may correspond to an abstract topic representing diverse aspects within the table. Next, the apparatus 100 may generate a set of detailed questions for each item αₙ based on the abstract item in Equation 1. Here, the set of detailed questions may be expressed by Equation 2 as follows.

$$𝒜 , 𝒬 = {\{ {𝒬}_{n} \}}_{n = 1}^{N} \qquad [ Equation 2 ]$$

Here, ϑₙ may refer to the detailed questions aimed at querying information to be captured from the table.

The apparatus 100 may generate detailed questions based on the table and a summary of the table, and produce an insight as an answer for each of the questions. Here, the apparatus 100 may extract an abstract item, representing one abstract topic across diverse aspects of the table using a LLM, through Equation 3.

$$𝒜 , 𝒬 = {LLM}_{teacher} ( t , s ) \qquad [ Equation 3 ]$$

Here, the apparatus 100 may generate an insight corresponding to a given question based on the LLM. Here, the insight may be expressed by Equation 4 as follows.

$$ℐ = {\{ {ℐ}_{n} \}}_{n = 1}^{N} \qquad [ Equation 4 ]$$

Here, the insight may be obtained based on relevant cell information providing explicit evidence from the table to answer the question. The relevant cell information may be expressed as Equation 5.

$$ℰ = {\{ {ℰ}_{n} \}}_{n = 1}^{N} \qquad [ Equation 5 ]$$

Here, ε may correspond to explicit evidence that provides an answer to the question. The apparatus 100 may exclude irrelevant information from the table based on the following Equation 6 and identify insights relevant to the question.

$$\begin{matrix}[ Equation 6 ] & \\ ℰ , ℐ = {LLM}_{teacher} ( t , s , 𝒬 ) & ( 3 )\end{matrix}$$

The apparatus 100 may perform a knowledge quality enhancement process through the knowledge quality enhancer 120, excluding low-quality knowledge and selectively distilling high-quality knowledge generated by the LLM through fact verification and importance scoring. For example, the apparatus 100 may utilize TAPEX trained on the Tab-FACT dataset as a critic model to verify insights. Here, the apparatus 100 may perform binary classification based on the critic model to evaluate the consistency of each table and insight set and perform filtering on the insights accordingly.

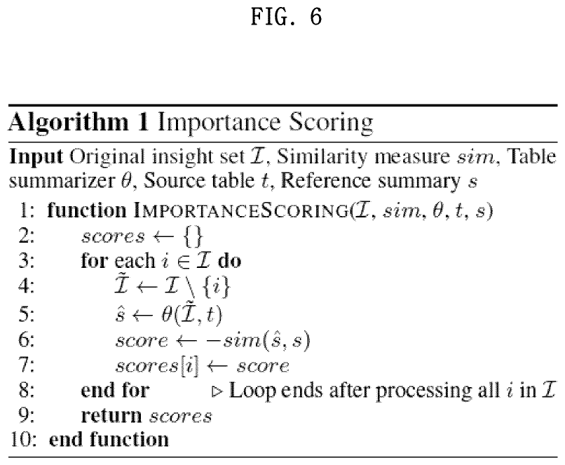

In addition, the apparatus 100 may review the usefulness of the generated knowledge by assessing the importance of each insight. Here, the apparatus 100 may evaluate the importance of each insight based on an importance scoring algorithm. Details of the importance scoring algorithm will be described with reference to FIG. 6.

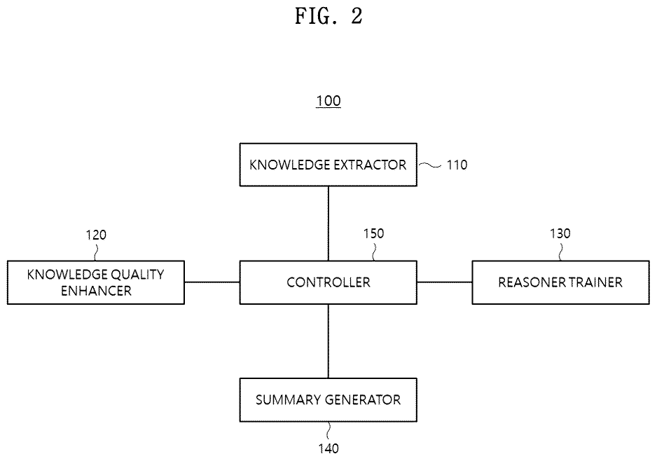

FIG. 2 is a diagram illustrating the functional configuration of the apparatus for table insight inference, as shown in FIG. 1.

Referring to FIG. 2, an apparatus 100 for table insight inference may include a knowledge extractor 110, a knowledge quality enhancer 120, a reasoner trainer 130, a summary generator 140, and a controller 150.

The embodiment of the present disclosure is not limited to including all of these components simultaneously. Depending on each embodiment, some components may be omitted, or some or all of these components may be included selectively. The operations of each component are described in detail below.

The knowledge extractor 110 may extract knowledge by progressively detailing the knowledge from an overall aspect (hereinafter, referred to as coarse knowledge) to detailed knowledge (hereinafter, referred to as fine-grained knowledge) in a table representing a reference summary and structured data. Here, the table may correspond to a structured form of data representation that organizes data into a structure of rows and columns, and may be utilized in various fields such as student grades, sales performance, health checkups, and inventory management. In addition, an aspect may be a specific perspective or analytical criterion for the data. For example, an aspect may be an analytical criterion based on variables such as time, region, product, or customer characteristics that define the table. The knowledge extractor 110 may obtain coarse knowledge about a table based on a reference summary and a table. For example, the knowledge extractor 110 may derive the coarse knowledge according to aspects, such as basic statistics such as the average, maximum, and minimum values for the table, based on the summary. In addition, the knowledge extractor 110 may extract fine-grained knowledge from the table by filtering detailed data based on coarse knowledge patterns and the relationships between the respective pieces of the coarse knowledge during the process of extracting the coarse knowledge.

For example, the knowledge extractor 110 may classify table data into diverse aspects and perform detailed data filtering according to the aspects to identify coarse knowledge patterns and relationships between the respective pieces of the coarse knowledge and extract fine-grained knowledge. Here, the knowledge extractor 110 may extract the fine-grained knowledge from the coarse knowledge by classifying table data according to diverse aspects, such as time, product, and region, and recognize patterns in the coarse knowledge according to the aspects. Furthermore, the knowledge extractor 110 is not limited to the above description, and may extract the fine-grained knowledge by analyzing relationships between the respective pieces of the coarse knowledge according to different aspects. For instance, the knowledge extractor 110 may extract the fine-grained knowledge based on relationships between the respective pieces of the coarse knowledge, such as time-based relationships, regional differences, age group correlations, and product-based variations.

In one embodiment, the knowledge extractor 110 may perform an aspect identification process on the table data 112 by analyzing the coarse knowledge-based reference summary 111, an aspect-specific question generation process to obtain answers from the table data 112, and an evidence specification process to derive evidence based on specific cells of the table through analysis of the fine-grained knowledge based on each aspect-specific question. Here, the knowledge extractor 110 may extract a general overview and key information about a specific topic or data from the coarse knowledge-based reference summary 111 and obtain initial insights into the data. In addition, the knowledge extractor 110 may analyze the content and structure of the table data and identify key aspects of the table data such as topic, category, time, region, and demographic characteristics.

In one embodiment, the knowledge extractor 110 may perform an aspect-specific question generation process to generate detailed questions to acquire more detailed knowledge for each aspect. Here, the knowledge extractor 110 may generate at least one question for each aspect. For example, the knowledge extractor 110 may derive a question about “the change in sales growth rate over the past three years” based on the time aspect and obtain detailed knowledge related to the question. In one embodiment, the knowledge extractor 110 may derive detailed knowledge based on each question by conducting comparative questions, trend analysis questions, and causal analysis questions for each aspect.

Here, the comparative questions may refer to questions that compare two or more data sets, the trend analysis questions may refer to questions about changes in data over time, and the causal analysis questions may refer to questions aimed at identifying the cause of a specific phenomenon. The knowledge extractor 110 may perform a process of generating aspect-specific questions based on comparative questions, trend analysis questions, and cause analysis questions, and may store at least one of the generated questions in a database.

In one embodiment, the knowledge extractor 110 may derive evidence for an answer to a generated question by performing an evidence specification process that uses fine-grained knowledge-based analysis to identify evidence based on specific cells of the table for each aspect-specific question. Here, the knowledge extractor 110 may perform an evidence specification process for a specific question and derive evidence based on actual data from specific cells of the table. For example, in order to derive the evidence of the answer for the question “What were the sales in Seoul in the first quarter of 2023?”, the knowledge extractor 110 may extract sales data from a table based on specific cells containing the “2023 Q1” and “Seoul” items and present the extracted sales data as evidence. The knowledge extractor 110 is not necessarily limited to the above description, and may identify keywords from an aspect-specific question based on an LLM and perform a keyword search on specific cells of the table to extract specific cells containing evidence for the question.

In one embodiment, the knowledge extractor 110 may generate knowledge by collecting aspects, questions, and evidence. Here, the knowledge extractor 110 may derive knowledge including aspect-specific questions and evidence by performing an aspect identification process, an aspect-specific question generation process, and an evidence specification process for the table data 112. In one embodiment, the knowledge extractor 110 may generate knowledge by synthesizing coarse and fine-grained knowledge from the table based on questions related to each aspect.

The knowledge quality enhancer 120 may refine extracted knowledge based on factual verification and select knowledge meeting or exceeding a predetermined threshold through importance scoring. Here, refining the extracted knowledge based on factual verification may correspond to a process of assessing the reliability of the extracted knowledge. For example, the knowledge quality enhancer 120 may perform factuality verification by comparing the extracted knowledge with the table data 112 to check whether the extracted knowledge matches the table data 112. In addition, the knowledge quality enhancer 120 may perform error detection on the knowledge by detecting logical errors and data interpretation errors from the knowledge based on the LLM. For example, the knowledge quality enhancer 120 may perform a reproducibility test on the table data 112 to verify whether consistent results are obtained after performing the same data analysis multiple times. The knowledge quality enhancer 120 is not necessarily limited to the above description, and may detect logical errors and data interpretation errors in knowledge by conducting data integrity checks, such as sampling error checks on the table data 112.

Additionally, selection based on importance scoring may refer to selecting the most important pieces of knowledge among the refined knowledge. For example, the knowledge quality enhancer 120 may set up importance scoring criteria based on a semantic similarity and select knowledge according to the importance scoring criteria. Here, the knowledge quality enhancer 120 may measure a semantic similarity for each piece of knowledge and assign importance scores differentially according to the importance scoring criteria. In one embodiment, the knowledge quality enhancer 120 may select the top K pieces of knowledge based on the importance scoring results, where K is a natural number.

In one embodiment, the knowledge quality enhancer 120 may determine refined knowledge by verifying whether the extracted knowledge matches the table data 112 and removing any knowledge with uncertain or erroneous information. Here, the knowledge quality enhancer 120 may perform data mapping between the extracted knowledge and the table data 112 to ensure that the table data 112 is accurately reflected in the knowledge without any change. In addition, the knowledge quality enhancer 120 may verify data referential integrity for knowledge and check the consistency of data connections between tables. This allows the knowledge quality enhancer 120 to prevent logical errors or contradictions in the relationship between the knowledge and the table data 112. In one embodiment, the knowledge quality enhancer 120 may determine knowledge with uncertain or erroneous information based on whether the data format and data range between the extracted knowledge and the table data 112 match each other, and extract refined knowledge by removing the knowledge with uncertain or erroneous information.

In one embodiment, the knowledge quality enhancer 120 may generate a summary based on refined knowledge, measure a semantic similarity with a reference summary, and perform importance scoring to select the top K (where K is a natural number) pieces of important knowledge. Here, the reference summary may be a summary to be compared with the generated summary. For example, the reference summary may be a summary received from a user. The knowledge quality enhancer 120 may measure a semantic similarity between the summary generated based on refined knowledge using the LLM and the reference summary. Here, the knowledge quality enhancer 120 may perform importance scoring of knowledge based on word matching between the summary and the reference summary, as well as the similarity in context and meaning between sentences of the summary and the reference summary.

In one embodiment, the knowledge quality enhancer 120 may assess the importance of knowledge by repeatedly evaluating the influence of insights on knowledge during the process of extracting a summary. Here, the influence of insights may correspond to a degree of change in summary quality caused by removing specific knowledge, and specifically refers to a process of generating a summary while sequentially removing extracted knowledge and measuring the similarity with the original summary. For example, after removing specific knowledge using a similarity measurement model, such as SBERT or BERTScore, the knowledge quality enhancer 120 may measure a semantic similarity between the generated summary and the reference summary and assign an importance score to knowledge. In one embodiment, the knowledge quality enhancer 120 may repeatedly evaluate the influence of insights on knowledge and perform importance scoring on the knowledge based on the average of the influence of insights. In addition, the knowledge quality enhancer 120 may perform knowledge importance scoring based on the influence of insights, list each piece of knowledge sequentially according to importance scores, and select the top k pieces of knowledge.

The reasoner trainer 130 may perform a question generation training process to analyze the reference summary and the table data 112 so as to generate questions for identifying the important knowledge, and may derive an answer with a reliability meeting or exceeding a predetermined threshold for each of the questions. Here, the question generation training refers to a process of automatically generating questions to evaluate knowledge importance based on the reference summary and the table data 112. For example, the reasoner trainer 130 may analyze each column, row, or data set of a table and extract a specific aspect from each column, row, or data set of the table. Afterwards, the reasoner trainer 130 may generate questions to select important knowledge based on the extracted aspect.

In one embodiment, the reasoner trainer 130 may generate an aspect-focused question to find necessary information from the table data 112 through the question generation training. For example, if receiving a table about a sports player's career, the reasoner trainer 130 may learn key aspects such as performance trends and factors affecting performance, and generate questions regarding “performance during a specific season” or “whether performance is consistent and what factors may sustain consistency.”

In one embodiment, the reasoner trainer 130 may, through evidence insight generation training, analyze the table data 112 and generate evidence-focused insights to generate reliable insights based on evidence. Here, the reasoner trainer 130 may analyze the table data 112 and generate insights to explore evidence regarding the question. For example, if the reasoner trainer 130 receives a question regarding “performance during a specific season” or “whether performance is consistent and what factors may sustain consistency,” the reasoner trainer 130 may generate insights such as “the player's goal performance peaked in the 2008-09 season, considering the goal record and injury record of the 2008-09 season,” and “a return to the original team is considered a factor regarding performance consistency.”

The summary generator 140 may incorporate questions and answers about important knowledge into an insight summary. Here, the insight summary may include questions about important knowledge and answers to the questions. The summary generator 140 may incorporate questions for analyzing the table data 112 and answers to the questions during a process of extracting important knowledge into an insight summary. For example, the summary generator 140 may organize the questions and answers in the form of introduction, body, and conclusion sections, and incorporate the organized questions and answers into the insight summary. Here, the summary generator 140 may include the overall context and importance of the summary in the introduction section, organize the questions and answers in the main body section to provide insights into important knowledge, and suggest future directions for the important knowledge in the conclusion section.

In one embodiment, the summary generator 140 may derive implicit relationships or patterns between the table data 112 based on the questions and answers about the important knowledge and predict future trends to incorporate into the insight summary. Here, the summary generator 140 may analyze the questions and answers about the important knowledge through pattern analysis and derive implicit relationships and patterns between the table data 112. The summary generator 140 may derive the implicit relationships and patterns between the table data 112 by performing pattern analysis, such as statistical analysis, time series analysis, and clustering, on the questions and answers. For example, the summary generator 140 may predict future market growth potential by analyzing the sales growth pattern of a specific product category and incorporate this insight into the insight summary.

The controller 150 may control the overall step of the apparatus 100 and may manage the control flow or data flow between the knowledge extractor 110, the knowledge quality enhancer 120, the reasoner trainer 130, and the summary generator 140.

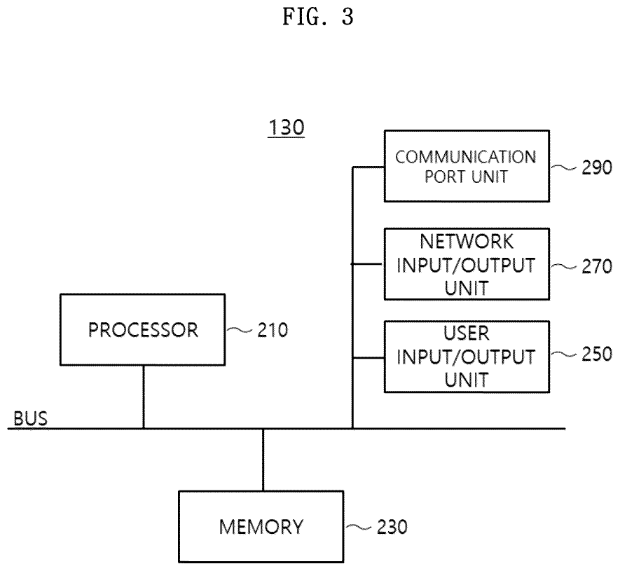

FIG. 3 is a diagram illustrating the system configuration of the apparatus for table insight inference, as shown in FIG. 1.

Referring to FIG. 3, an apparatus 100 for table insight inference may include a processor 310, a memory 330, a user input/output unit 350, a network input/output unit 370, and a communication port unit 390.

The processor 310 may execute a question-and-answer-based table insight inference service procedure according to an embodiment of the present disclosure, manage the memory 330 that is read from or written to during this process, and schedule a synchronization time between volatile and non-volatile memory in the memory 330. The processor 310 may control the overall step of the apparatus 100, and may be electrically connected to the memory 330, the user input/output unit 350, the network input/output unit 370, and the communication port unit 390 to control the data flow therebetween. The processor 310 may be implemented as a central processing unit (CPU) or graphics processing unit (GPU) of the apparatus 100.

The memory 330 may include an auxiliary storage device implemented as non-volatile memory, such as a solid-state disk (SSD) or hard disk drive (HDD), used to store all data required for the apparatus 100, and may include a main memory device implemented as volatile memory, such as random access memory (RAM). In addition, the memory 330 may store a set of commands for executing a question-and-answer-based table insight inference method according to the present disclosure, when executed by the electrically connected processor 310.

The user input/output unit 350 may include components for receiving user input and outputting specific information to the user. For example, the user input/output unit 350 may include an input device with adapters such as a touch pad, touch screen, virtual keyboard, or pointing device, and an output device with adapters such as a monitor or touch screen. In one embodiment, the user input/output unit 350 may correspond to a computing device connected via remote access, and in this case, the personalized Q&A apparatus 100 may be performed as an independent server.

The network input/output unit 370 may provide a communication environment for connecting to a user terminal through a network and may include adapters for communication, such as a local area network (LAN), metropolitan area network (MAN), wide area network (WAN), and value added network (VAN). In addition, for the wireless transmission of learning data, the network input/output unit 370 may be implemented to provide a short-range communication function, such as WiFi and Bluetooth, or a wireless communication function of 4G or higher.

The communication port unit 390 may be implemented as a port mapping table that performs data routing during the transmission and reception of data over a network. Here, the communication port unit 390 may differentiate the communication session between the knowledge extractor 110 and the server by assigning a unique source port to the knowledge extractor 110, thereby preventing data collisions during the data transmission and reception process.

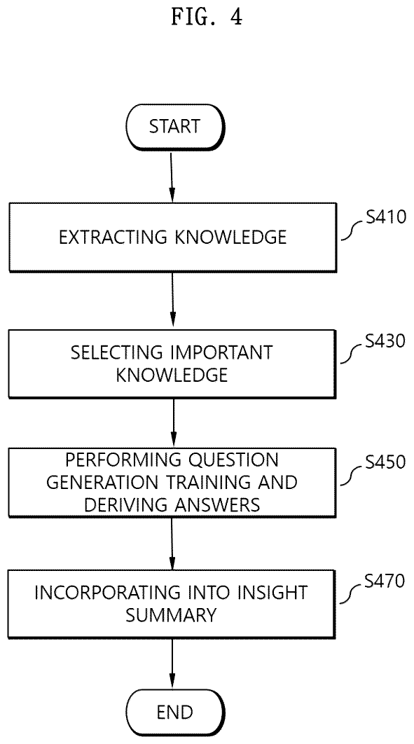

FIG. 4 is a flowchart illustrating a table insight inference method according to the present disclosure.

Referring to FIG. 4, an apparatus 100 for table insight inference may extract knowledge by progressively refining the knowledge from an overall aspect to detailed knowledge in a table representing a reference summary and structured data (S410). The apparatus 100 may perform factuality-verification-based refinement on the extracted knowledge using a knowledge quality enhancer 120 and select important knowledge meeting or exceeding a predetermined threshold through importance scoring (S430).

The apparatus 100 may perform question generation training, through a reasoner trainer 130, to analyze the reference summary and table data 112 so as to generate questions for identifying important knowledge, and derive an answer with a reliability meeting or exceeding a predetermined threshold for each of the questions (S450). The apparatus 100 may incorporate questions and answers about important knowledge into an insight summary using a summary generator 140 (S470).

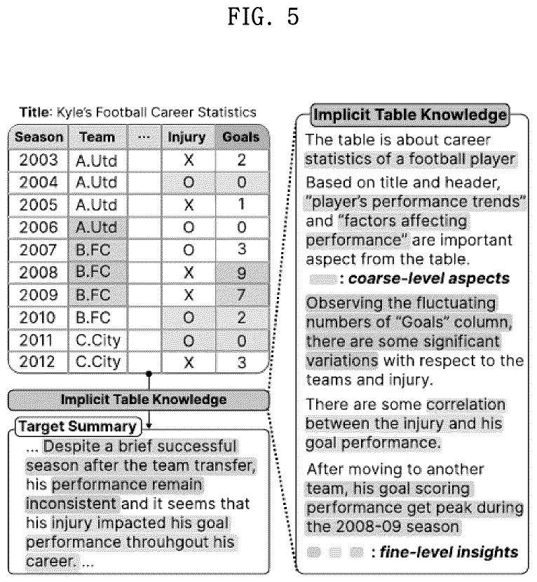

FIG. 5 is a diagram illustrating an example of a table according to one embodiment of the apparatus for table insight inference, as shown in FIG. 1.

In FIG. 5, an apparatus 100 for table insight inference may provide a table containing knowledge from diverse aspects based on a large language model (LLM). Here, the apparatus 100 may extract a reference summary 111 from a table composed of rows and columns including a specific aspect. In one embodiment, the apparatus 100 may extract knowledge by detailing coarse and fine-grained knowledge from the table. Here, the apparatus 100 may extract coarse knowledge from the reference summary 111 and the table, and derive fine-grained knowledge based on patterns and relationships between the coarse knowledge. For example, the apparatus 100 may receive the reference summary 111, such as “Company A's sales in the first quarter of 2023 increased by 20% due to the launch of a new product,” and extract coarse knowledge such as “Company A's sales in the first quarter of 2023 increased” and “Company A launched a new product in 2023.” In addition, the apparatus 100 may analyze the relationships between the respective pieces of the coarse knowledge and extract fine-grained knowledge, such as “The launch of the new product had a positive effect, and sales growth is expected if a similar strategy is used in the future”.

FIG. 6 is a diagram illustrating an importance scoring algorithm according to one embodiment of the apparatus for table insight inference, as shown in FIG. 1.

In FIG. 6, an apparatus 100 may, using an importance scoring algorithm, select important knowledge meeting or exceeding a predetermined threshold.

Specifically, the apparatus 100 may generate a subset of knowledge data extracted from table data 112 and measure a semantic similarity between a summary and a reference summary 111. Then, the apparatus 100 may remove a specific subset of data and calculate an importance score based on a degree of change in summary quality due to the removed subset of data.

Here, the apparatus 100 may repeatedly perform the importance score calculation process until calculating an importance score for the entire knowledge, and select the top K insights to generate a refined training set. For example, the apparatus 100 may mine and refine-grained knowledge (A, Q, E, I) to generate refined knowledge D′={(t,s,(A,Q,E,I))}. Here, A may correspond to an aspect, Q may correspond to a question, E may correspond to evidence, I may correspond to an insight, t may correspond to an input table, and s may correspond to the reference summary 111. The apparatus 100 may generate refined knowledge by verifying whether the refined knowledge matches the table data 112 and removing any knowledge with uncertain or erroneous information from the refined knowledge.

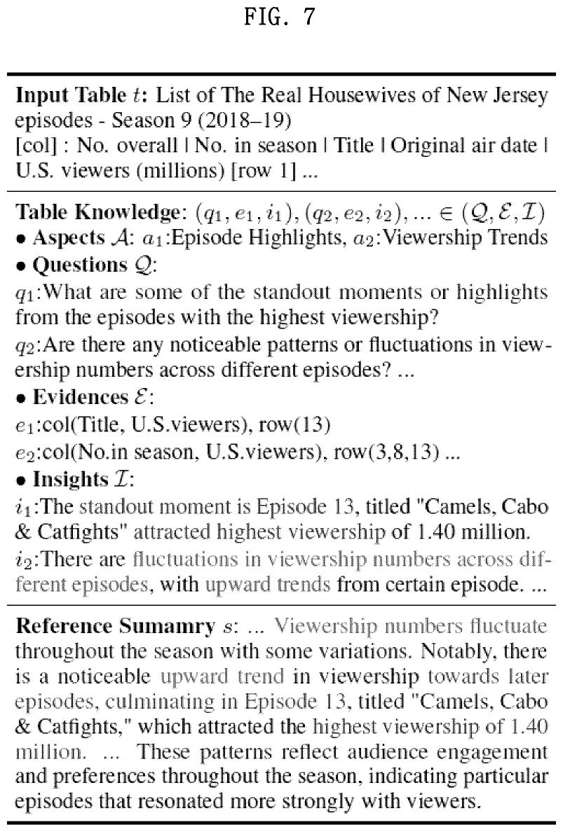

FIG. 7 is a diagram illustrating an example of knowledge extraction according to one embodiment of the apparatus for table insight inference, as shown in FIG. 1.

In FIG. 7, an apparatus 100 may receive a table containing information about the “List of episodes of Real Housewives of New Jersey Season 9 (2018-19).” Here, the columns of the table may include the total episode number, episode number within the season, title, first air date, and number of US viewers (in millions), while the rows may contain table data 112. The apparatus 100 may extract aspects from a table and generate aspect-specific questions. For example, the apparatus 100 may extract aspects such as episode highlights and viewership trends from the table and generate questions based on these aspects, such as “What are the notable moments or highlights of the highest-rated episodes?” and “Are there any notable patterns or fluctuations in viewership between episodes?”.

The apparatus 100 may provide insights into questions such as, “The most notable moment was in episode 13, titled ‘Camels, Cabo & Catfights’, which reached a peak of 1.40 million viewers, “and” There were fluctuations in viewership across episodes, with some episodes showing upward trends in viewership.” Here, the apparatus 100 may present columns and rows from the table data 112, containing information such as US viewers and episode numbers within a season, as evidence for the insights. In one embodiment, the apparatus 100 may provide important insights by deriving questions and evidence based on the table data 112, and explain the insights by comparing the insights with the reference summary 111. For example, the apparatus 100 may provide important insights, such as viewership patterns and trends, and compare the important insights with the reference summary 111.

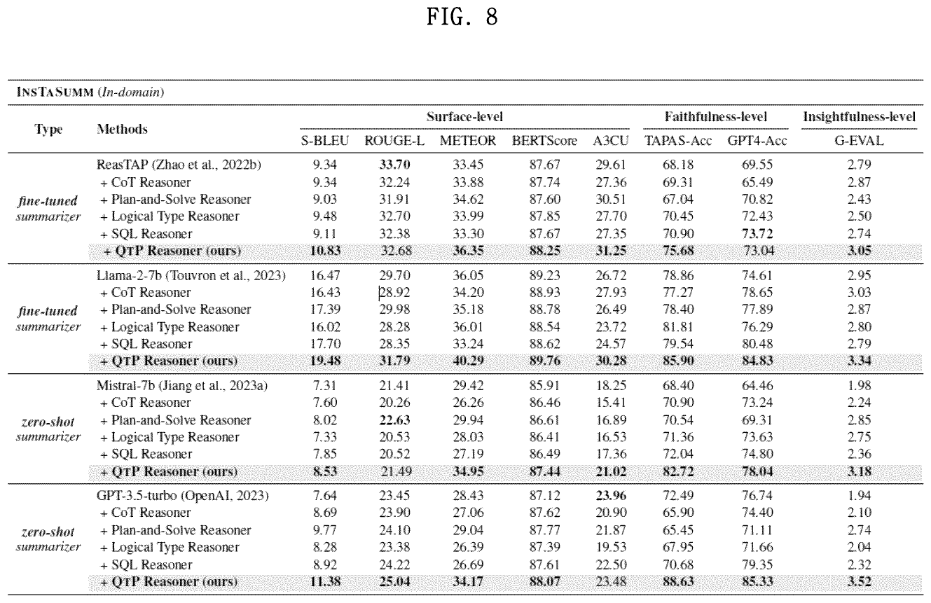

FIG. 8 is a diagram illustrating an experimental process for measuring the knowledge extraction effect of the apparatus for table insight inference, as shown in FIG. 1.

For FIG. 8, an experiment was conducted to measure how the insights provided by the apparatus 100 offer useful guidance to a summarizer in generating high-quality table summaries. The following describes the experimental procedure.

### 1.1 Data Set

First, the performance of a test set held out from the data set is evaluated to train the apparatus 100 within the domain. Since existing open-domain table-to-text generation datasets mainly focus on sentence-level generation or are limited to specific domains, a more comprehensive testbed is needed to evaluate the framework. Therefore, a refined version of the original dataset, called INSTASUMM, is built, focusing solely on generating insight table summaries in paragraph format from input tables.

Next, INSTASUMM is constructed by adopting QT-Summ as the source dataset. QT-Summ is a query-focused table summarization dataset, which is collected by human-annotated multiple queries and summaries for a single table input. As QTSumm considers informativeness when curating queries and covers diverse aspects with multiple query-summary pairs for each table, QTSumm includes rich and in-depth information in the annotated descriptions compared to general table-to-text datasets. Therefore, INSTASUMM is constructed to include a paragraph-style summary for each individual table by aggregating diverse query-focused summaries from QT-Summ. Rather than simply concatenating the query-focused summaries, GPT-4 is prompted to articulate the aggregated content in a more fluent form, resulting in a single summary.

Next, Sci-GEN is selected as an out-of-domain dataset to further evaluate the generalizability of the framework. Here, SciGEN may correspond to a domain-specific table-to-text dataset collected from scientific articles. Generating long-form descriptions from a given table requires intensive reasoning, and the test split of the medium setting for the experiments is used.

### 1.2 Evaluation Metrics

To evaluate table summarization performance from different aspects, various automatic evaluation metrics are used across four levels. The automatic evaluation metrics are as follows:

(1) Surface Level: SacreBLEU, ROUGE, METEOR, BERTScore, and A3CU are adopted to evaluate lexical overlap and contextual similarity between reference and inferred summaries.

(2) Faithfulness Level: TAPAS-Acc and GPT4-Acc are used to evaluate the factual accuracy of the generated summaries.

(3) Insightfulness Level: The analytical depth of each summary is evaluated using the G-EVAL approach. Specifically, GPT-4 is prompted to evaluate the insightfulness of generated summaries for given table-summary pairs on a 1-5 Likert scale and report the average score.

(4) Pairwise Quality Comparison: Pairwise comparisons are conducted by presenting the source table and two summaries generated by different models, and GPT-4 is asked to choose one based on various criteria. Here, the pairwise comparisons are performed based on three criteria: naturalness, comprehensiveness, and informativeness of the table summaries.

### 1.3 Table Summarizer

To evaluate the usefulness of the reasoner in various scenarios, both fine-tuned and zero-shot table summarization models are all considered. The table summarization models used in the experiments are as follows.

(1) Fine-tuned Summarizer: Two foundational models, ReasTAP and Llama-2-7b-chat, are considered.

(2) Zero-shot Summarizer: For zero-shot evaluation, two large-scale models, GPT-3.5-turbo and Mistral-7b, are considered. In particular, knowledge generated by the apparatus 100 is provided as additional input in both scenarios. For fine-tuned summarizers, the input is augmented during both the training and inference stages, whereas for zero-shot summarizers, knowledge is provided only during the inference.

### 1.4 Baselines

To evaluate how knowledge affects summarization performance, QTP is compared with the following baselines:

(1) Without Knowledge: First, an end-to-end baseline is considered, where the summarizer directly predicts a target summary without externalizing implicit knowledge.

(2) Knowledge Generation with Step-by-Step Reasoning: Another baseline is considered, which uses step-by-step reasoning with a general large language model to generate knowledge for augmenting the summarizer. Specifically, two knowledge models, including CoT Reasoner and Plan-and-Solve (P&S) Reasoner, are implemented to generate implicit knowledge based on step-by-step reasoning.

(3) Knowledge Generation with Symbolic Reasoning: Task-specific reasoners, which guide knowledge generation through logical table operations, are then considered as baselines. For the Logical Type (LT) Reasoner, nine predefined operation types are adopted as controls for knowledge generation. Additionally, for the SQL Reasoner, SQL queries are used as guidelines for generation. For a fair comparison, all baseline reasoners are trained with the same backbone model as that of the apparatus 100, with the distilled reasoning ability of an LLM.

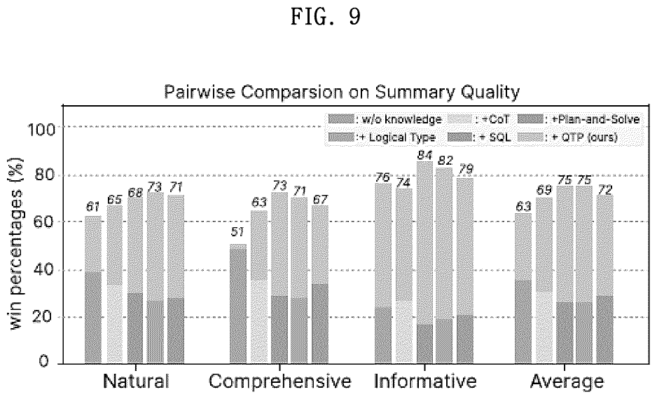

FIG. 9 is a drawing showing a comparison of summary quality according to the experimental results of FIG. 8.

In FIG. 9, the knowledge-based approach of the apparatus 100 is compared with various end-to-end summary generation methods. Here, the result shows that a summary conditioned on knowledge from the apparatus 100 significantly improves the performance of both fine-tuned and zero-shot summarizers. Additionally, it is found that summaries based on the knowledge from the apparatus 100 are more natural, comprehensive, and information-rich. This suggests that enhancing the end-to-end summary generation method with the apparatus 100 is beneficial for capturing relevant knowledge and producing higher-quality summaries. In addition, the consistent performance improvements across various backbone summarizers indicate that the knowledge-based approach of the apparatus 100 is generally effective.

In addition, the apparatus 100 is compared with other knowledge-augmented baselines that generate knowledge through two different types of reasoning: step-by-step reasoning (CoT, Plan-and-Solve) and symbolic reasoning (Logical Type, SQL). Here, it is observed that incorporating baseline knowledge models into table summarization results in only marginal improvements, and in some metrics, even leads to a decline in performance compared to the end-to-end model. Specifically, it is found that symbolic reasoning improves the factual accuracy of summaries but falls short of enhancing insightfulness.

In addition, the step-by-step reasoning model achieves similar performance to the apparatus 100 in terms of surface and insightfulness metrics through step-by-step inference, but still suffers from a low reliability (accuracy). In contrast, the apparatus 100 is shown to robustly handle this′insightfulness-reliability′trade-off due to the mining process from coarse knowledge to fine-grained knowledge based on explicitly identified evidence.

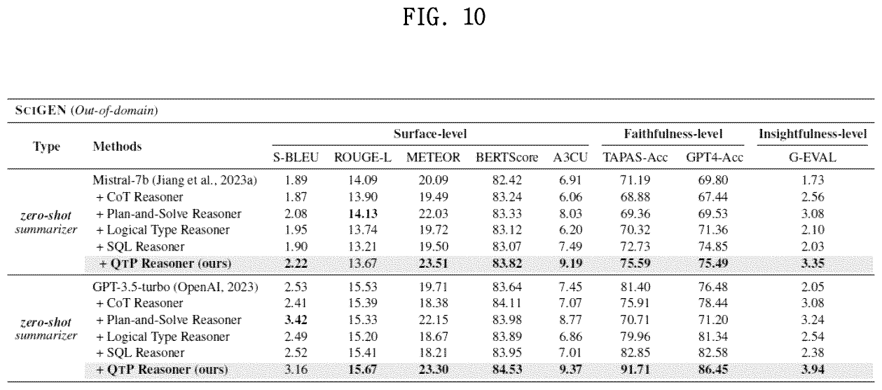

FIG. 10 is a diagram showing the summary results outside the domain according to the experimental results of FIG. 8.

For FIG. 10, it is observed that the test domain outperformed all baselines in an unseen domain out-of-domain scenario during the training phase, in accordance with the experimental results in FIG. 8, confirming the generalizability of the apparatus 100 outside the domain. This is attributed to the generalization ability of the apparatus 100, which stems from the flexibility of self-questioning the required knowledge from the unseen tables outside the domain. Here, generalization may correspond to the model asking itself what knowledge is needed for understanding new data on which it has not been trained. While large language models may generalize across a variety of tasks, the apparatus 100 is shown to capture implicit knowledge about unseen domains, offering more powerful guidance.

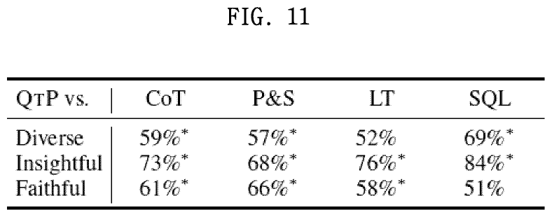

FIG. 11 is a diagram showing a human evaluation of the knowledge quality generated from the apparatus for table insight inference, as shown in FIG. 1.

In FIG. 11, the quality of knowledge is evaluated in terms of diversity, insightfulness, and faithfulness to assess the ability of the apparatus 100 to generate implicit knowledge. The evaluation process involves randomly sampling 100 inference results from the INSTASUMM test set and asking three different human evaluators to compare the knowledge generated by the apparatus 100 with that of the baseline models. This reveals that while the baseline models achieved comparable performance in terms of knowledge diversity relative to the apparatus 100, the baseline models struggle to generate insightful and faithful knowledge. This suggests that the apparatus 100 generates higher-quality knowledge, providing more in-depth and accurate analysis.

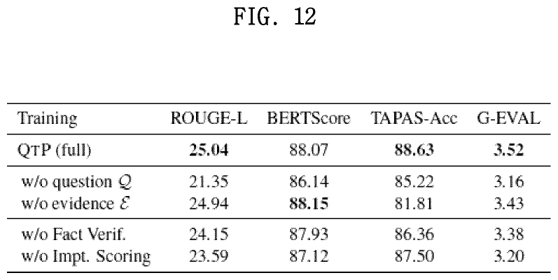

FIG. 12 is a diagram showing the effect of knowledge quality improvement resulting from knowledge refinement.

In FIG. 12, to investigate the effectiveness of the knowledge quality enhancement strategy, two different training datasets are generated by omitting each strategy and training different versions of each strategy. Here, the results show that factuality verification has a greater impact on faithfulness, while importance scoring impacts the surface-level and insightfulness metrics more significantly. These results suggest that a quality enhancement strategy for selecting core knowledge that aligns factually with the table is essential for training a reliable knowledge model, and also show that the apparatus 100 provides more comprehensive analyses and more detailed information than baselines. In FIG. 12, while the baselines only list facts from the table, the summary generated by the apparatus 100 is structured with a logical flow that transitions smoothly from a general overview to specific details, resulting in a more natural outcome.

The above description is merely exemplary description of the technical scope of the present disclosure, and it will be understood by those skilled in the art that various changes and modifications can be made without departing from the spirit and scope of the present disclosure as set forth in the following claims.

### [National Research and Development Project Supporting the Present Invention]

[Project Serial No] 2710006677
[Task Project No] RS-2020-II201361
[Name of Department] Ministry of Science and ICT
[Task Management (Professional) Institution Name] Institute of Information and Communications Technology Planning and Evaluation
[Research Project Name] Nurturing ICT and Broadcasting Innovation Talents
[Research Task Name] Artificial Intelligence Graduate School Support (Yonsei University)
[Name of Task Performing Organization] Yonsei University Industry-University Cooperation Foundation
[Research Period] 2024.01.01˜2024.12.31

### [National Research and Development Project Supporting the Present Invention]

[Project Serial No] 1711197848
[Task Project No] 00244689
[Name of Department] Ministry of Science and ICT
[Task Management (Professional) Institution Name] National Research

### Foundation of Korea

[Research Project Name] General Researcher Support Project
[Research Task Title] Domain Knowledge Graph-Based Reliable Language Model Inference Framework
[Name of Task Performing Organization] Yonsei University Industry-University Cooperation Foundation
[Research Period] 2024.03.01˜2025.02.28

[Detailed Description of Main Elements]

| | |
|---|---|
| 130: artificial intelligence server | |
| 100: table insight inference apparatus | |
| 110: knowledge extractor | |
| 111: reference summary | 112: table data |
| 120: knowledge quality enhancer | |
| 130: reasoner trainer | 140: summary generator |
| 150: controller | |
| 310: processor | 330: memory |
| 350: user input/output | 370: network input/output unit |
| 390: communication port | |

What is claimed is:

1. An apparatus for question-and-answer-based table insight inference, comprising:
a knowledge extractor configured to extract knowledge by progressively detailing the knowledge from an overall aspect, which is referred to as coarse knowledge, to detailed knowledge, which is referred to as fine-grained knowledge, in a table representing a reference summary and structured data;
a knowledge quality enhancer configured to perform refinement based on factuality verification of the extracted knowledge and to select important knowledge meeting or exceeding a predetermined threshold through importance scoring;
a reasoner trainer configured to perform question generation training to analyze the reference summary and the table data so as to generate questions for identifying the important knowledge, and to perform evidence-insight generation training to derive an answer with a reliability meeting or exceeding a predetermined threshold for each of the questions; and
a summary generator configured to incorporate questions and answers about the important knowledge into an insight summary.

2. The apparatus of claim 1, wherein the knowledge extractor is further configured to perform an aspect identification process for the table data by analyzing the reference summary based on the coarse knowledge, an aspect-specific question generation process to obtain answers from the table data, and an evidence specification process to derive evidence based on specific cells in the table through fine-knowledge-based analysis for each aspect-specific question.

3. The apparatus of claim 2, wherein the knowledge extractor is further configured to generate the knowledge by collecting the aspects, the questions, and the evidence.

4. The apparatus of claim 1, wherein the knowledge quality enhancer is further configured to determine the refined knowledge by verifying whether the extracted knowledge matches the table data and by removing knowledge containing uncertain or erroneous information from the extracted knowledge.

5. The apparatus of claim 4, wherein the knowledge quality enhancer is further configured to generate a summary based on the refined knowledge, measure a semantic similarity with the reference summary, perform the importance scoring, and select the top K pieces of important knowledge, where K is a natural number.

6. The apparatus of claim 1, wherein the reasoner trainer is further configured to generate aspect-focused questions to find necessary information from the table data through the question generation training.

7. The apparatus of claim 6 wherein, the reasoner trainer is further configured to, through the evidence insight generation training, analyze the table data and generate evidence-focused insights to generate reliable insights based on evidence.

8. The apparatus of claim 1, wherein the summary generator is further configured to derive implicit relationships or patterns among the table data based on questions and answers about the important knowledge, predict future trends, and incorporate the predicted future trends into the insight summary.

9. A method for question-and-answer-based table insight inference, the method performed by a question-and-answer-based table insight inference apparatus, comprising:
a knowledge extracting step of extracting knowledge by progressively detailing the knowledge from an overall aspect, referred to as coarse knowledge, to detailed knowledge, referred to as fine-grained knowledge, in a table representing a reference summary and structured data;
a knowledge quality enhancing step of performing refinement based on factuality verification of the extracted knowledge and selecting important knowledge meeting or exceeding a predetermined threshold through importance scoring;
a reasoner training step of performing question generation training to analyze the reference summary and the table data so as to generate questions for identifying the important knowledge, and performing evidence-insight generation training to derive an answer with a reliability meeting or exceeding a predetermined threshold for each of the questions; and
a summary generating step of incorporating questions and answers about the important knowledge into an insight summary.
